(19) United States
(12) Patent Application Publication
(10) Pub. No.: US 2015/0090004 A1
(43) Pub. Date: Apr. 2, 2015

(54) Electrical Conductor and Method of Making Same

(71) Applicant: OneSubsea IP UK Limited, London (GB)

(72) Inventor: Jean-Francois Noel, Soreidgrend (NO)

(73) Assignee: OneSubsea IP UK Limited, London (GB)

(21) Appl. No.: 14/504,046

(22) Filed: Oct. 1, 2014

Related U.S. Application Data
(60) Provisional application No. 61/885,089, filed on Oct. 1, 2013.

(51) Int. Cl. H01B 17/22; B23P 11/02; G01N 3/24; H01B 1/16; H01B 17/16; G01N 3/08; H01B 13/06; H01B 3/12

(52) U.S. Cl. CPC H01B 17/22; H01B 13/06; B23P 11/025; H01B 3/12; H01B 1/16; H01B 17/16; G01N 3/08; G01N 3/24
USPC 73/37; 29/825; 174/98

(57) ABSTRACT

An electrical conductor includes an electrically non-conductive plate, an electrically conductive pin extending through the plate, and a frame member fitted around an outer edge of the plate. The frame member is configured to pre-load the plate with a compressive stress. In particular, the frame member may pre-load the plate with the compressive stress that is sufficiently high enough such that a sum of the compressive stress, tensile stress, and shear stress components generated in the plate under high-pressure conditions is compressive overall.

### CROSS-REFERENCE TO RELATED APPLICATIONS

This application is a continuation of U.S. Application No. 61/885,089, filed on Oct. 1, 2013, which is incorporated herein by reference in its entirety.

### TECHNICAL FIELD

The present disclosure relates generally to electrical conductors. More particularly, the present disclosure relates to the electrical conductor design and a method of making same.

### BACKGROUND ART

The oil production industry has to contend with some of the most inhospitable conditions anywhere. These include thermal shock, high pressures, highly corrosive, abrasive environments, and wide temperature variations that may range between about −46° C. (about −50° F.), such as when in the vicinity of the choke and/or when in use in colder environments (e.g., Alaska), and up to about 205° C. (about 400° F.) when downhole or for steam assisted gravity drainage (SAGD) applications. A further, and frequently major, factor is mechanical shock and fatigue due to vibration caused by fluid flow past the connector.

While oil and gas industry is among the most demanding applications for conductors, other uses and industries like weaponry, gas turbines, jet engines, and the nuclear industry also have very high specification requirements. In all of these industries, electrical conductors, such as feedthroughs or electrodes, need to show high corrosion resistance, high temperature resistance, and high pressure bearing capacity. Further, domains like medical applications, while potentially not as demanding as the latter applications, instead require very high standards for chemical compounds or materials that are used within the conductor design.

Several technologies are available that are incorporated into the design of electrical conductors. For example, an electrical conductor may include a metal pin within a glass insulator, which is typically borosilicate, and a metal housing, in which the conductor is sealed by wetting and shrink fitting the glass with metal. In this example, however, the corrosion resistance of the glass is not suitable for many of the chemicals found in oil and gas applications, and further the maximum service temperature is limited by the glass transition temperature. Another technique consists of including a metal pin within a polyether ether ketone (PEEK) insulator and a metal housing with the conductor sealed using O-rings. However, with this design, the O-rings are limited in terms of chemicals that are compatible with the O-rings, the minimum and maximum temperatures to which the O-rings are exposed, and use within rapid gas decompression applications. Further, PEEK materials have a rather low glass transition temperature, typically about 150° C. (about 300° F.), which leads to creep deformation complications for long term use at high temperatures.

Another example of electrical conductor includes a metal pin positioned within a ceramic insulator and a metal housing, in which the conductor is sealed by wetting braze material on both metal and ceramic parts of conductor. In this example, brazing requires wetability of the surfaces, which often requires a coating to be applied on the ceramic or the metal. This coating may be susceptible to corrosion. Further, brazing does not generate compression stresses into the ceramic/glass and may instead generate stress concentrations, which reduces the pressure bearing capacity of the ceramic. Furthermore, the brazing material is usually not bio-compatible, and therefore not suitable for medical applications, and also not corrosion resistant enough for long term service in a corrosive environment, such as found oil and gas or any other of the harsh environment applications mentioned above. Accordingly, the design and development of electrical conductors remains a priority to increase the compatibility of the electrical conductors with one or more of the industries and applications mentioned above.

### SUMMARY OF THE DISCLOSURE

According to an aspect of the present disclosure, an electrical conductor includes an electrically non-conductive plate with a first face and a second face that oppose each other and with an outer edge defined between the first face and the second face. The conductor further includes an electrically conductive pin extending through the plate, and a frame member fitted around the outer edge of the plate that pre-loads the plate with a compressive stress. The frame member may pre-load the plate with the compressive stress that is sufficiently high enough such that a sum of the compressive stress, tensile stress, and shear stress components generated in the plate under high-pressure conditions is compressive overall. In one or more embodiments, the plate may include electrically insulating ceramic. In some embodiments, the insulating ceramic may include a ceramic compound made of a several ceramics, or a compound with alloying elements containing ceramic.

In one or more embodiments, the electrically conductive pin may include electrically conductive ceramic, cemented carbide, or cermet. In some embodiments, the conductive ceramic may include boride, carbide, or nitride, and may further include at least one metal selected from the group IV, V, and VI elements. In some embodiments, the cermet is a heterogeneous combination of metal(s) or alloy(s) with one or more ceramic phases. In some embodiments, the cemented carbide may include a ceramic phase with at least one element selected from the group consisting of tungsten, tantalum, titanium, niobium, a mixture and a compound of such materials, and/or a metallic binder phase including metal or a metal alloy.

In some embodiments, a plurality of conductive pins may be extending and going through the non-metallic plate.

According to some embodiments, the plate may be a disk coaxial with the electrically conductive pin.

According to another embodiment, the extremities of the pin may be flush with the first and/or second face of the plate.

In one or more embodiments, the plate and the pin may be combined together by bonding. In some examples, bonding includes hot pressing or hot isostatic pressing the plate and the electrically conductive pin together. In some other examples, bonding may include diffusion bonding.

According to some embodiments, the plate may be or include a disk and the frame member may circumscribe the outer edge of the plate to substantially uniformly apply compressive stress around the circumference of the outer edge.

According to some embodiments, the plate and the frame member may be assembled by shrink-fitting the frame member around the plate.

According to some embodiments, a pressurized fluid contacts an outer surface of the frame member as well as the first face of the plate such that pressure from the fluid may increase the compressive stress applied by the metallic frame member to the outer edge of the plate.

According to some embodiments, the frame member may include an annular shoulder that supports an outer portion of the second face of the plate, in which the second face may be exposed to less pressure than the first face.

According to some embodiments, the frame member may include an interfacing layer disposed between the outer edge of the plate and the annular shoulder. In one or more embodiments, the interfacing layer may be formed from a metal that is softer than the metal forming the frame member. In some embodiments, the interfacing layer may be formed from gold, platinum, palladium, tantalum, iridium, or nickel.

According to some embodiments, the first face of the plate may be exposed to a first environment, the second face of the plate may be exposed to a second environment, and the extremities of the pin may respectively be exposed to and contact the first environment and the second environment.

According to an aspect of the present disclosure, a method of fabricating an electrical conductor may include positioning an electrically conductive pin to extend through an electrically non-conductive plate, the plate comprising a first face and a second face that oppose each other with an outer edge defined between the first face and the second face, and shrink-fitting a frame member around the outer edge of the plate at a shrink-fit temperature such that the frame member applies a compressive stress to the plate at any temperature below the shrink-fit temperature.

According to an aspect of the present disclosure, a system to measure properties of a fluid may include an electrically non-conductive plate including a first face exposed to the fluid and a second face opposing the first face, the first face and the second face of the plate including an outer edge defined therebetween, an electrically conductive pin extending through the plate that contacts the fluid to be measured, and a metallic frame member fitted around the outer edge of the plate and adapted to pre-load the plate with a compressive stress that is sufficiently high enough such that a sum of the compressive stress, tensile stress, and shear stress components generated in the plate is compressive.

These together with other aspects, features, and advantages of the present disclosure, along with the various features of novelty, which characterize the invention, are pointed out with particularity in the claims annexed to and forming a part of this disclosure. The above aspects and advantages are neither exhaustive nor individually or jointly critical to the spirit or practice of the disclosure. Other aspects, features, and advantages of the present disclosure will become readily apparent to those skilled in the art from the following description of exemplary embodiments in combination with the accompanying drawings. Accordingly, the drawings and description are to be regarded as illustrative in nature, and not restrictive.

### BRIEF DESCRIPTION OF THE DRAWINGS

To assist those of ordinary skill in the relevant art in making and using the subject matter hereof, reference is made to the appended drawings, in which like reference numerals refer to similar elements:

FIG. 1 represents schematically one embodiment of the proposed electrical conductor;

FIG. 2 represents another embodiment of the proposed electrical conductor;

FIG. 3 represents another alternative for the proposed electrical conductor;

FIG. 4 represents another embodiment of the proposed electrical conductor;

FIG. 5 represents another embodiment of the proposed electrical conductor; and

FIG. 6 represents another embodiment of the proposed electrical conductor.

### DESCRIPTION OF EXEMPLARY EMBODIMENTS

The following discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not structure or function. Further, like reference numbers and designations in the various drawings indicated like elements.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. The use of “top,” “bottom,” “above,” “below,” and variations of these terms is made for convenience, but does not require any particular orientation of the components.

Ceramic materials typically have poor flexural and tensile strength but maintain an overall higher compressive strength. To increase the low flexural and/or tensile strength, the ceramic may be pre-loaded with a high compressive stress. When a ceramic is used as part of a pressure design, the ceramic may be pre-loaded with a compressive stress sufficiently high that the sum of any tensile stress produced by the fluid pressure, and the compressive stress produced by the pre-loading, is overall always compressive.

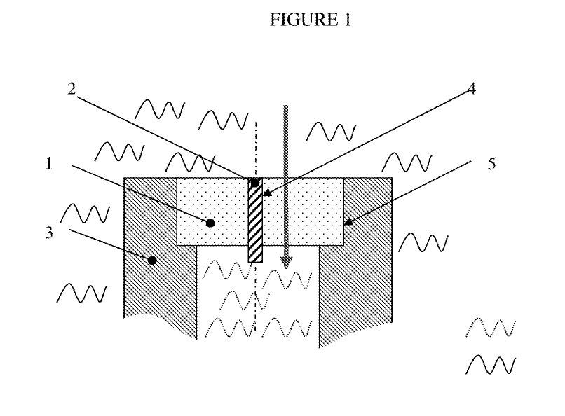

FIG. 1 shows one example of a proposed electrical conductor. A plate 1 may be made from or include an electrically non-conductive material, such as a ceramic with high electrical resistance or low dielectric constant, and may include a pin 2 that may be made from or include an electrically conductive material, such as a ceramic, a cemented carbide, or cermet. Though only one pin 2 is shown in FIG. 1, the present disclosure is not so limited, and may also include any number more than one. The pin 2 may extend through the thickness of the insulating plate 1, thereby allowing electrons to flow along the pin 2 and through the insulating material with low electrical resistance. In the embodiment of FIG. 1, the disk 1 may be circular and the pin 2 may be coaxial with the disk outer diameter, though the present disclosure is not so limited. Also, shown on FIG. 1, the pin 2 may have a length that is longer than the thickness of the plate 1, though the present disclosure is not so limited. In an embodiment in which the plate 1 and the pin 2 include ceramic, cemented carbide, and/or cermet, the plate 1 and pin 2 may be combined together by hot pressing or hot isostatic pressing to induce bonding between them, which may enable leak tightness at the interface 4 of the plate 1 and the pin 2.

The plate 1 may be electrically insulating and corrosion resistant and may be made from or include one or more ceramics or ceramic phases, a ceramic compound made from or including multiple ceramics, or a compound with alloying elements containing ceramic. The ceramic(s) phase(s) may include metallic oxide, boride, carbide, nitride, carbonitride, silicide, carbon (including diamond), or a mixture or compound of such materials. The ceramic may have grain boundaries or be a single crystal. The conductive pin 2 may be made from or include an electrically conductive and corrosion resistant ceramic, cermet, or cemented carbide. The electrically conductive ceramic may include or be formed from boride, carbide, or nitride, and may also include or be formed from one or more metals selected from the group IV, V, and VI elements. For example, the conductive pin may be made from or include titanium diboride (TiB₂)).

The cermet may be or include a binder, such as a heterogeneous combination of one or more metals or alloys binder, with one or more ceramic phases that may constitute between approximately 15% and 85% by volume and may include relatively little solubility between metallic and ceramic phases at the preparation temperature. The ceramic phase may be or include metallic oxide, boride, carbide, nitride, carbonitride, silicide, carbon (including diamond), or a mixture or compound of such materials. The metal binder may be or include a metal or a metallic alloy, such as containing mostly iron (Fe), nickel (Ni), cobalt (Co), manganese (Mn), molybdenum (Mo), chromium (Cr), tungsten (W), and/or titanium (Ti). The cemented carbide may be or include a ceramic phase and/or a metal binder phase. The ceramic phase may be or include W, such as WB, tantalum (Ta), such as TaC, Ti, such as TiC, and niobium (Nb), such as NbC, or a mixture or compound of such materials, and the metal binder phase may be or include metal or a metallic alloy, such as containing Ni and/or Co. As mentioned, the pin 2 and the plate 1 may be bonded by hot pressing or hot isostatic pressing. Additionally or alternatively, diffusion bonding may be used to bond the pin 2 and the plate 1 to each other.

As shown on FIG. 1, a frame member 3, such as a metallic frame member, may have a length that is longer than the thickness of the plate 1. The inner diameter of the frame member 3 may include a shoulder that complements in shape but may be slightly smaller than the circular outer edge 5 of the plate 1 such that the frame member 3 may compressively pre-load the plate 1, such as compressively pre-load all points of the plate 1, with compressive stress. The relative dimensions between the diameter of the outer edge 5 of the plate 1 and the shoulder of the frame 3, as well as the strength of the material, steel, or other material or metal forming the frame, are chosen such that the sum of all stresses (e.g., tensile, shear, and compressive) applied to the plate 1 remains compressive. In at least one embodiment, the plate is compressively pre-loaded to overcome the tensile stress generated in/on the plate by pressure applied to at least one of the first and/or second faces, such as when exposed to a pressurized fluid as will be further explained.

In addition to the shoulder, the frame member 3 may further include an annular interfacing layer disposed between the edge 5 of the plate 1 and the support shoulder of the frame. The interfacing layer may be formed from or include a metal that is softer than the metal forming the frame member such that the interfacing layer deforms slightly when subjected to the compressive pre-load from the frame member. Such deformation of the interfacing layer may enable the compressive pre-load applied around the circumference of the outer edge 5 to be substantially uniform at all points. Additionally, the interfacing layer may include an annular rim disposed between the support shoulder and the plate 3 to provide further retention of the plate 1 in response to fluid pressure applied to plate face. The material of the interfacing layer may be much softer than the ceramic and the hard metal used in the frame, but not so soft that the interfacing layer flows out of the opening between the plate and the frame. A suitable material of the interfacing layer may include gold (Au), platinum (Pt), palladium (Pd), tantalum (Ta), iridium (Ir), and/or Ni.

In one or more embodiments, the design and mounting of the plate 1 within the frame 3 may provide a soft metal interface enabling leak tightness. The soft metal interface may include a pure precious metal (like, but not limited to gold) to provide corrosion resistance. The shoulder 5 may prevent the ceramic to slide and/or move within the housing under extreme pressures.

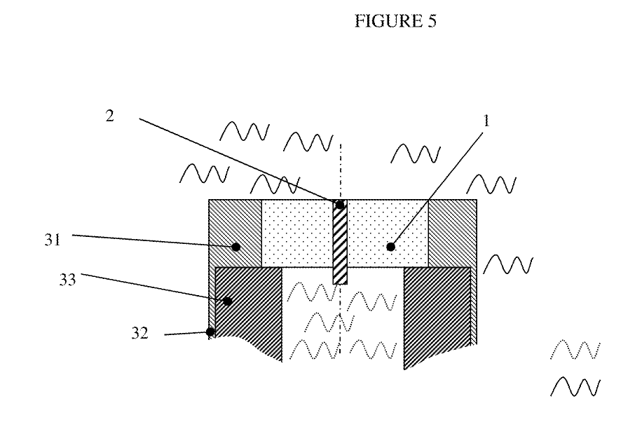

In embodiment shown on FIG. 5, the frame 3 may include a ring 31 around the ceramic disk 1 and a thin flexible wall 32 that lands on a holder 33 (e.g., metallic holder), such as under high pressure. This design may prevent stress concentrations in the corners that may be detrimental for sealing and stress distribution. The design may also allow for the frame 3 to be self-energized under pressure to increase the security of the fit of the frame 3 with the holder 33. This device may be able to sustain high differential pressure and high temperature, and may also be corrosion resistant such that the design enables the pin and the plate to be made from or include non-metallic material, such as ceramic, cermet, or cemented carbide. For example, one or more embodiments in accordance with the present disclosure may be capable of being used within a high-pressure and/or high-temperature environment, which may be defined as a well having one or more of the following characteristics: an undisturbed bottomhole temperature of greater than 300° F. (149° C.), a pore pressure of at least 0.8 psi/ft (˜15.3 lbm/gal), and/or requiring a blowout preventer with a rating in excess of 10,000 psi (68.95 MPa).

An electrical conductor in accordance with one or more embodiments of the present disclosure may be used as a sensor to measure fluids or gas properties, such as in an adverse environment where high pressure, high temperature, and/or corrosive media need to be separated across sides of the sensor. For example, an electrical conductor may be used as an antenna or to gather a conductivity measurement. An electrical conductor may also be used as an electrical feedthrough to transfer data or power through such adverse environment where high pressure, high temperature, or corrosive media need to be separated across sides of the feedthrough. For example, an electrical conductor in accordance with one or more embodiments of the present disclosure may be used as a connector in downhole application or on Christmas trees (e.g., production trees) as a redundant or wetted process barrier.

An environment that may be found within an oil and gas application is represented on FIG. 1, in which an arrow shows a direction of the differential pressure across the electrical conductor from the highest pressure to the lowest. In this embodiment, one face of the plate 1 faces the environment of high pressure, where plain waves are shown, while the opposed face of the plate 1 faces the environment of lower pressure, where dotted waves are shown. A pressurized fluid in the high pressure environment may contact an outer surface of the frame member 3, as well as a face of the plate 1, such that pressure from the fluid increases the compressive stress applied by the frame member 3 to the outer edge of the plate 1.

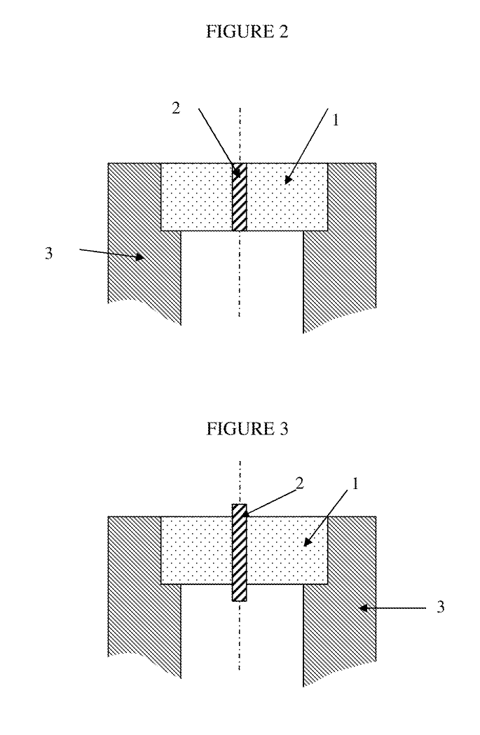

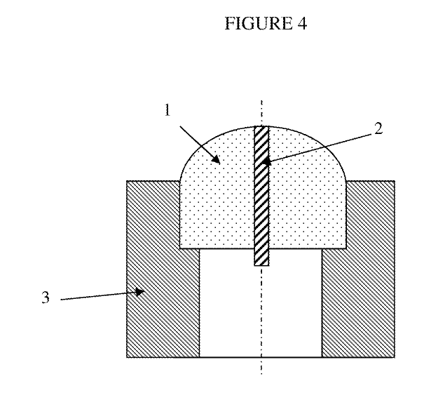

FIG. 2 represents a second proposed embodiment, in which the pin 2 may have one or both extremities (e.g., ends) flush with the faces of the plate 1. FIG. 3 represents an embodiment in which the pin 2 may have one or both extremities protruding from the faces of the plate 1. FIG. 4 represents another embodiment in which one face of the plate 1 may be curved with an extremity of the pin 2 may be formed as flush with the curved face.

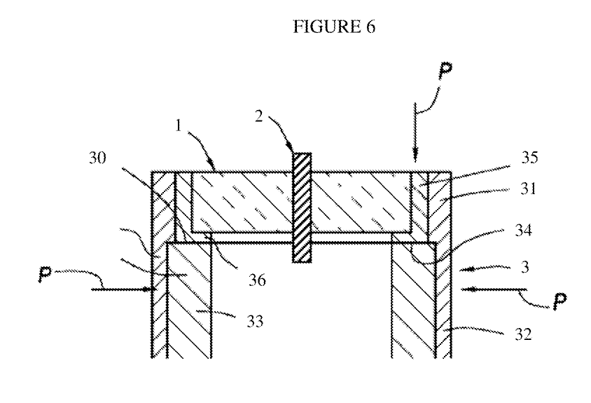

FIG. 6 illustrates another embodiment of an electrical conductor with an increased pressure-resisting capability in accordance with one or more embodiments of the present disclosure. The pin 2 may extend through the thickness of the insulating plate 1. Further, in this embodiment, the frame member 3 may include a wall 32 (which may be referred to as the outer tube or the first tubular shape) that tightly and concentrically overlies a holder 33 (which may be referred to as an inner tube or the second tubular shape). The tubes 32 and 33 may be joined together by various suitable joining methods, such as welding, electron beam welding, or laser beam welding. A ring end 31 of the frame member 3 may extend over a distal end 30 of the inner tube 33 such that the distal end 30 of the inner tube 33 defines a supporting shoulder 34. The provision of the supporting shoulder 34 may substantially increase the capability of the frame member 3 to support the plate 1 under high-pressure conditions.

In addition to the supporting shoulder 34, an annular interfacing layer 35 may be included disposed between the plate 1 and the frame member 3, such as positioned within the inner diameter of the outer tube 32, and the support shoulder 34. The interfacing layer 35 may be formed from or include a metal that is softer than the metal forming at least the outer tube 32 of the metallic frame member 3 such that the layer 35 deforms slightly when subjected to the compressive pre-load applied by the ring 31 and the frame member 3. Such deformation of the interfacing layer 35 may insure that the compressive pre-load applied around the circumference of the outer edge of the plate 1 is substantially uniform at all points. Additionally, the interfacing layer 35 may also include an annular rim 36 disposed between the support shoulder 34 and the outer portion of the plate 1 to provide further retention of the plate 1 in response to fluid pressure applied to face of the plate 1.

In one embodiment, when pressurized fluid is introduced, the resulting pressure may not only press downward against the upper face of the plate 1, but may also act against the outer diameter of the outer tube 32 forming part of the frame member 3, thereby increasing the compressive stress applied around the outer edge of the plate 1 and further increasing the frictional grip between the outer edge of the plate 1 and the interfacing layer 35 and the inner diameter of the ring 31 of the frame member 3. Thus the electrical conductor may be self-energizing. Of course, the relative dimensions between the diameter of the outer edge of the plate 1, the interfacing layer 35, and the inner diameter of the distal end of the tube 32 as well as the strength of the steel or other metal forming the tube 32 are chosen such that the sum of all stresses (i.e. tensile, shear and compressive) applied to the plate 1 may always be compressive during the operation of the electrical conductor.

During fabrication of an electrical conductor in accordance with one or more embodiments, the metal has a higher thermal expansion than the ceramic. The parts of the electrical conductor may be manufactured with dimensions and tolerances such that the inner diameter of the frame member may be smaller than the outer diameter of the plate at ambient temperature, where the ambient temperature is defined as the environment where the frame member is used, but excluding the environment where the frame member is manufactured. For example, the ambient temperature may be in the range of about −100° C. (−148° F.) to about 300° C. (572° F.). The difference between these diameters at ambient temperature is known as interference. The amount of interference determines the pre-loading of the plate. The strength of the material forming the frame member, or portions of the frame member, may ultimately determine and/or limit the amount of pre-loading that can be created.

The frame member or portions thereof may be heated to a temperature that increases the size of the inner diameter via thermal expansion to an extent that allows the plate (which may be kept at a lower temperature) to be inserted into the inner diameter of the frame member. If the metal is heated too much, the frame member may pass a phase transition temperature and change in properties. In the current embodiment of the present disclosure, the temperature of the metal throughout the process may be controlled to ensure that this from occurring. In the case of high strength steel, as well as other candidate high strength nickel and cobalt alloys, exposure to heating above 500° C. (932° F.) may impact the mechanical properties of the material, the significance of the impact being related to the length of the exposure. The local heating of the metal may be achieved in any suitable manner, such as through induction heating. The assembly may be facilitated by the use of assembly fixtures and jigs to avoid handling of very hot parts. The plate and the frame member may then be allowed to cool back to ambient temperature, thereby shrink-fitting the plate within the inner diameter of the frame member. The resulting contraction of the frame member pre-loads the outer edge of the plate with the aforementioned predetermined and/or desired amount of compressive stress.

Further, during fabrication of an electrical conductor in accordance with one or more embodiments, the inner and outer tubes may be precisely assembled through a transitional fit. The inner diameter of the portion of the outer tube surrounding the inner tube may be chosen to be slightly larger or identical to the outer diameter of the inner tube at ambient temperature. The outer tube may be assembled with the inner tube, and kept in place before welding or otherwise joining the tubes and the frame member together. For example, the joining may be achieved by various joining methods including but not limited to TIG welding, electron beam welding, and laser beam welding.

When no interfacing layer is used, the metallic part (outer and inner tubes) may be heated to the required temperature, and the plate may be inserted into the inner diameter of the ring end of the frame member such that the plate rests on the top end of the inner tube. Cooling to lower temperatures may achieve the shrink-fit, as described above, with regard to the plate and the ring-shaped distal end of the outer tube. The plate may then be held in place by shrink-fit forces and the frictional forces between the plate and the metal of the end of the frame member. The plate may further be supported by the end of the inner tube such that when the electrical conductor is exposed to pressure in the direction indicated by the arrows in FIG. 6, the plate may rest on the end of the inner tube to be held in place.

The design of the frame member allows the distal end to act as a ring, which is compressed around the outer edge of the plate, particularly when the electrical conductor is exposed to pressurized fluid from above in the figures. The thinner wall of the frame member facilitates the compressive, radially inward motion of the ring-shaped distal end. This may be the “self-energizing” sealing and stress-compensating feature of the design. Below the transition point between the ring and the wall of the outer tube, the thinner wall is supported by the outer wall of the inner tube in such a way to not be deformed, even at very high pressures.

When an interfacing layer is provided, the outer and inner tubes may be attached to one another by transitional fit and welding in one embodiment. Next, the interfacing layer may be applied around the inner diameter of the ring of the frame member and over the support shoulder of the inner tube. The material of the interfacing layer may be selected such that the forces exerted on interfacing layer during the shrink-fit process will allow the interfacing layer to deform. In such an embodiment, the ring may have an inner diameter that is larger, such as marginally larger, than the outer diameter of the plate to provide room for the interfacing layer.

The soft metal forming the interfacing layer may be deposited onto the hard metal forming the outer and inner tubes through a variety of methods, including, but not limited to, vapor deposition, electroplating, or fusion with a preformed shape. After the soft metal of the interfacing layer has been deposited onto the indicated surfaces, the interfacing layer may be machined to have an inner diameter that at room temperature and intended operating temperatures is smaller than the diameter of the outer edge of the plate.

A shrink-fit between the plate and the interfacing layer may be next achieved in the same manner as described before. The tubes and the interfacing layer may be heated such that the inner diameter of the interfacing layer becomes large enough via thermal expansion to receive the plate. The resulting electrical conductor may then be allowed to cool to ambient temperature, whereupon the resulting thermal contraction shrink-fits all of the aforementioned components together in a frictional or interference type fit. The plate may now be held in place by the shrink-fit forces and the frictional forces between the plate and the interfacing layer. The soft metal forming the interfacing layer may be deformed by the pressure exerted by the hard metal forming the outer tube as the outer tube of the frame member contracts through cooling. This may cause the soft metal to flow such as to fill any microscopic corrugations on the surface of the outer edge of the plate or the surfaces of the inner diameter of the distal ring end of the outer tube. Such metallic flow may reduce local stress concentrations at the surface of the plate caused by imperfections in the surface finish of the metal tube, and may also improve the seal between the ceramic and the metal, essentially making the seal helium leak tight, or hermetic. The plate may further be supported by the support shoulder of the inner tube and the rim of the interfacing layer such that, when the electrical conductor is exposed to pressure in the direction indicated in the figures, the plate may rest on the end of the inner tube, and thus be held in place.

Further, a shrink-fit between the one or more pins and the plate may be used to couple the pin and the plate to each other. For example, the pin may be cooled with respect to the plate (e.g., the plate may also be heated with respect to the pin), thereby increasing the size of a hole formed through the plate with respect to the pin. The pin may then be positioned within and/or extended through the hole formed within the plate, in which the pin may then be allowed to heat with respect to the plate. As the pin and plate then regulate to the same temperature, the plate may then shrink-fit around the pin to form an interference fit and couple the pin to the plate.

Whereas many alterations and modifications of the present invention will no doubt become apparent to a person of ordinary skill in the art after having read the foregoing description, it is to be understood that the particular embodiments shown and described by way of illustration are in no way intended to be considered limiting. It is noted that the foregoing examples have been provided merely for the purpose of explanation and are in no way to be construed as limiting of the present invention. While the present invention has been described with reference to exemplary embodiments, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. An electrical conductor, comprising:
an electrically non-conductive plate;
an electrically conductive pin extending through the plate; and
a frame member fitted around an outer edge of the plate that pre-loads the plate with a compressive stress.

2. The electrical conductor of claim 1, wherein the frame member is fitted so as to pre-load the plate with the compressive stress high enough such that a sum of the compressive stress, tensile stress, and shear stress components generated in the plate under high-pressure conditions is compressive overall.

3. The electrical conductor of claim 1, wherein the plate comprises an electrically insulating ceramic material.

4. The electrical conductor of claim 3, wherein the electrically insulating ceramic material comprises a ceramic compound, and wherein the ceramic compound comprises either a plurality of ceramics or alloying elements containing ceramic.

5. The electrical conductor of claim 1, wherein the plate comprises an electrically insulating monolithic crystal.

6. The electrical conductor of claim 1, wherein the pin comprises electrically conductive ceramic, cemented carbide, cermet, or metal.

7. The electrical conductor of claim 6, wherein the electrically conductive ceramic comprises boride, carbide, or nitride, and wherein the electrically conductive ceramic further comprises at least one metal selected from group IV, V, and VI elements.

8. The electrical conductor of claim 6, wherein the cermet comprises at least one of a heterogeneous metal combination and a heterogeneous alloy combination, and wherein the cermet further comprises at least one ceramic phase.

9. The electrical conductor of claim 6, wherein the cemented carbide comprises:
a ceramic phase comprising at least one element of tungsten, tantalum, titanium, and niobium; and
a metallic binder phase comprising at least one of a metal and a metal alloy.

10. The electrical conductor of claim 1, wherein the pin comprises a plurality of pins with each of the plurality of pins extending through the plate.

11. The electrical conductor of claim 1, wherein the plate comprises a disk coaxial with the pin.

12. The electrical conductor of claim 1, wherein an extremity of the pin is flush with at least one face of the plate.

13. The electrical conductor of claim 1, wherein the plate and the pin are bonded together.

14. The electrical conductor of claim 13, wherein the plate and pin are bonded by at least one of hot pressing, hot isostatic pressing, and diffusion bonding.

15. The electrical conductor of claim 1, wherein the plate comprises a disk and the frame member circumscribes the outer edge and such that compressive stress is substantially uniformly applied around the circumference of the outer edge.

16. The electrical conductor of claim 1, wherein metallic frame member is shrink fit around the plate.

17. The electrical conductor of claim 1, wherein the frame member is fitted around the outer edge of the plate such that, when pressure is applied to an outer surface of the frame member, the compressive stress applied by the frame member to the outer edge of the plate increases.

18. The electrical conductor of claim 1, wherein the frame member comprises an annular shoulder that supports an outer portion of a face of the plate.

19. The electrical conductor of claim 1, further comprising an interfacing layer disposed between the outer edge of the plate and the frame member.

20. The electrical conductor of claim 19, wherein the frame member comprises metal and the interfacing layer comprises metal, and wherein the metal of the interfacing layer is softer than the metal of the frame member.

21. The electrical conductor of claim 20, wherein the interfacing layer comprises at least one of gold, platinum, palladium, tantalum, iridium, and nickel.

22. The electrical conductor of claim 1, wherein one side of the plate is exposed to a first environment and another side of the plate is exposed to a second environment, and extremities of the pin contact the first environment and the second environment.

23. A method of fabricating an electrical conductor, comprising:
cooling an electrically conductive pin with respect to an electrically non-conductive plate;
extending the pin through the plate; and
shrink-fitting the plate around the pin such that the plate applies a compressive stress to the pin.

24. A method of fabricating an electrical conductor, comprising:
extending an electrically conductive pin through an electrically non-conductive plate; and
shrink-fitting a frame member around an outer edge of the plate at a temperature such that the frame member applies a compressive stress to the plate at any temperature below the shrink-fitting temperature.

25. A system to measure properties of a high-pressure fluid, the system comprising:
an electrically non-conductive plate configured to be exposed to the fluid;
an electrically conductive pin extending through the plate such that the pin is configured to be in contact with the fluid to be measured; and
a metallic frame member fitted around an outer edge of the plate and configured to pre-load the plate with a compressive stress that is sufficiently high such that a sum of the compressive stress, tensile stress, and shear stress components generated in the plate is overall compressive.
